(19) United States
(12) Patent Application Publication
(10) Pub. No.: US 2016/0332171 A1
(43) Pub. Date: Nov. 17, 2016

(54) A MULTI-CYCLONE DUST SEPARATING APPARATUS

(71) Applicant: NEDERLANDSE ORGANISATIE VOOR TOEGEPAST-NATUURWETENSCHAPPELIJK ONDERZOEK TNO, 's-Gravenhage (NL)

(72) Inventors: Andreas Mattheus Maria Moons, 's-Gravenhage (NL); Ellemieke Mary-Rose Henquet, 's-Gravenhage (NL)

(21) Appl. No.: 15/112,552

(22) PCT Filed: Jan. 23, 2015
(86) PCT No.: PCT/NL2015/050041

§ 371 Date: Jul. 19, 2016

(30) Foreign Application Priority Data
Jan. 24, 2014 (EP) 14152436.3

(51) Int. Cl. B04C 5/28; B04C 5/04

(52) U.S. Cl. CPC B04C 5/28; B04C 5/04

(57) ABSTRACT

A multi-cyclone dust separating apparatus comprises a housing with an air inflow port, an air outflow port separate from the air inflow port and an air flow channel extending in an air flow direction from the air inflow port to the air outflow port. The apparatus further comprises a plurality of cyclones arranged in a matrix arrangement and in the air flow channel. Each cyclone comprises a cylindrical portion defining an inside vortex space. The cylindrical portion has a top end and a lower end. A conical portion contiguous to the lower end has a dust opening at its bottom. An air inlet is arranged tangentially with regard to the cylindrical portion and opens in the inside vortex space. The air inlet has an effective air passage surface area. An air outlet tube having an air outlet passage is arranged at the top end of the cylindrical portion and extends into the inside vortex space. The plurality of cyclones comprises at least one module of cyclones, which comprises a top module plate to which a number of cyclones is connected to. The top module plate comprises through going air passages, each communicating with a respective air outlet tube. The air passage surface areas of the air inlets of all the cyclones of the number of cyclones of said at least one module are at least approximately identical.

The invention relates to a multi-cyclone dust separating apparatus. Such multi-cyclone dust separating apparatuses are employed in ventilation systems, suction systems, exhaust hoods and air treatments units of buildings such as schools, residences, factories and utilities. In addition, such multi-cyclone dust separating apparatuses are also employed in vacuum cleaners, in particular industrial vacuum cleaners. Please note that as used in the present application dust is not restricted to a particular type of dust particles but can be composed of any kind of dust particle.

A disadvantage of the present day available multi-cyclone dust separating apparatuses is that they are rather expensive, in particular since the multi-cyclone dust separating apparatuses are custom made for the intended purpose. Furthermore, present day multi-cyclone dust separating apparatuses are not efficient in separating dust particles having a small diameter, so called fine dust, so that such present day multi-cyclone dust separating apparatuses need to be combined with more traditional filtering systems. This latter combination is not only expensive but sometimes impossible to use in view of the sometimes limited available space where the multi-cyclone dust separating apparatuses and the traditional filtering systems need to be installed.

The present invention therefore aims at providing a multi-cyclone dust separating apparatus which can easily and in a relatively economic manner be adapted for different uses. In addition, the present invention aims at providing a compact multi-cyclone dust separating apparatus which is able to separate even fine dust from air.

The present invention provides a multi-cyclone dust separating apparatus comprising:

a housing with an air inflow port, an air outflow port separate from the air inflow port and an air flow channel extending in an air flow direction from the air inflow port to the air outflow port;

a plurality of cyclones mounted inside the housing and arranged in the air flow channel, said plurality of cyclones being arranged in a matrix arrangement, each cyclone comprising:
a cylindrical portion defining an inside vortex space, said cylindrical portion having a top end and a lower end;
a conical portion contiguous to the lower end and having a dust opening at its bottom;
an air inlet arranged tangentially with regard to the cylindrical portion and opening in the inside vortex space, said air inlet having an effective air passage surface area; and

an air outlet tube having an air outlet passage, said air outlet tube being arranged at the top end of the cylindrical portion and extending into the inside vortex space, said plurality of cyclones comprising at least one module of cyclones, said at least one module of cyclones comprising a top module plate to which a number of cyclones is connected to, said top module plate comprising through going air passages, each communicating with a respective air outlet tube, the air passage surface area of the air inlet of all the cyclones of the number of cyclones of said at least one module being at least approximately identical. Preferably the plurality of cyclones is provided by one or more modules, meaning that the total number of cyclones within the apparatus is only present in modules. By using such modules of cyclones it is possible to pre-manufacture the modules of cyclones and that a different number of modules can be combined in dependence of the intended use.

In an advantageous embodiment of a multi-cyclone dust separating apparatus according to the invention the apparatus comprises at least a first module of cyclones and at least one further module of cyclones, the first module of cyclones being releasably connected in an airtight manner to the at least one further module of cyclones forming an assembled unit of modules, said first module of cyclones being arranged in the housing upstream of the at least one further module of cyclones or said at least one further module of cyclones being arranged transversely adjacent the first module of cyclones, seen in a direction transverse to the air flow direction, the air passage surface area of the air inlet of the cyclones of said at least one further module and being equal to the air passage surface area of the air inlet of the cyclones of the first. In this manner the capacity of the apparatus can be increased or adapted by connecting a desired number of modules to each other. By using an airtight connection the correct operation of the apparatus is guaranteed.

It is then advantageous when each module of cyclones comprises connection means arranged for providing a releasable connection to another module of cyclones so that connecting modules together can be performed in a relatively quick and easy manner. Preferably the connection means are quick-coupling means, so that no tools are necessary to connect or disconnect the modules to and from each other, respectively.

In a further embodiment of a multi-cyclone dust separating apparatus according to the invention the multi-cyclone dust separating apparatus comprises a first module of cyclones and a second module of cyclones separated from the first module of cyclones, said first module of cyclones being arranged in the housing upstream of the second module of cyclones, the air passage surface area of the air inlet of the cyclones of said first module being larger than the air passage surface area of the air inlet of the cyclones of said second module. Preferably, the top module plate of each module of cyclones is mounted in the housing under a tilting angle, the tilting angle being such that the dust openings of the cyclones of each module are directed to the air inflow port. In an alternative embodiment of a multi-cyclone dust separating apparatus according to the invention the multi-cyclone dust separating apparatus comprises a first assembled unit of modules and a second assembled unit of modules separated from the first assembled unit of modules, said first assembled unit of modules being arranged in the housing upstream of the second assembled unit of modules, the air passage surface area of the air inlet of the cyclones of said first assembled unit of modules being larger than the air passage surface area of the air inlet of the cyclones of said second assembled unit of modules. Preferably, the top module plate of each module of each assembled unit of modules cyclones is mounted in the housing under a tilting angle, the tilting angle being such that the dust openings of the cyclones of each module of each assembled unit of modules are directed to the air inflow port. In this manner the apparatus can effectively separate dust having larger dimensions by the cyclones of the first module or the first assembled unit of modules, while dust having smaller dimensions is separated by the cyclones of the second module or the second assembled unit of modules, respectively. In case the air which is to pass the apparatus contains dust with a relatively large range of dimensions it is preferred that the apparatus contains a series of separate modules or separate assembled units of modules of which the cyclones have a decreasing air passage surface area in air flow direction.

In case the top module plate encloses a tilting angle with regard to the air flow direction, the outlet of air from an upstream module or assembled unit of modules forms the inlet of air for the adjacent downstream module or assembled unit, respectively.

A multi-cyclone dust separating apparatus according to the invention can be manufactured in an economical manner when the modules of cyclones are identical to each other.

In a still further embodiment of a multi-cyclone dust separating apparatus according to the invention each of the cyclones further comprises an internal dust collector, which internal dust collector is preferably removably connected in an airtight manner to the cyclone. Please note that with the expression internal is meant that the dust collector is part of the cyclone and is also positioned within the housing. In an alternative embodiment of a multi-cyclone dust separating apparatus according to the invention the apparatus comprises an external dust collector releasably connected in an airtight manner to a module of cyclones or to an assembled unit of modules. Please note that with the expression external is meant that the dust collector is not part of the cyclone itself but is arranged separately therefrom, in particular a dust collector which is removably connected in an airtight manner to the module or the assembled unit of modules. The internal and external dust collector are arranged such as to receive dust coming out of the dust opening of the cyclone(s).

In order to separate even the finest dust particles or smallest air pollution from air a multi-cyclone dust separating apparatus according to the invention comprises at least one module of which the effective air passage surface area of the cyclones thereof has a value in a range between 2 mm² and 450 mm². Preferably this at least one module is the most downstream module, seen in air flow direction.

It is particularly advantageous from a manufacturing point of view when the top module plate of said at least one module of cyclones of an embodiment of the inventive apparatus is rectangular or square.

In a still further advantageous embodiment of a multi-cyclone dust separating apparatus according to the invention the air outlet tubes of the cyclones of said at least one module of cyclones are integrally connected to the top module plate to form a first sub-unit and the cylindrical portion and conical portion of the cyclones of said at least one module are integrally connected to the cylindrical portions and conical portions of adjacent cyclones to form a second sub-unit and the first and second sub-units are releasably connected to each other in an airtight manner to form the at least one module. In this manner maintenance and cleaning of the cyclones within a module can be performed in an easy manner. In a particular advantageous embodiment of the invention the first and the second sub-unit are manufactured from plastics and are formed by injection moulding.

The invention will be further explained with reference to the Figures, in which non-limiting exemplary embodiments of a multi-cyclone dust separating apparatus in accordance with the invention are shown. In the drawing:

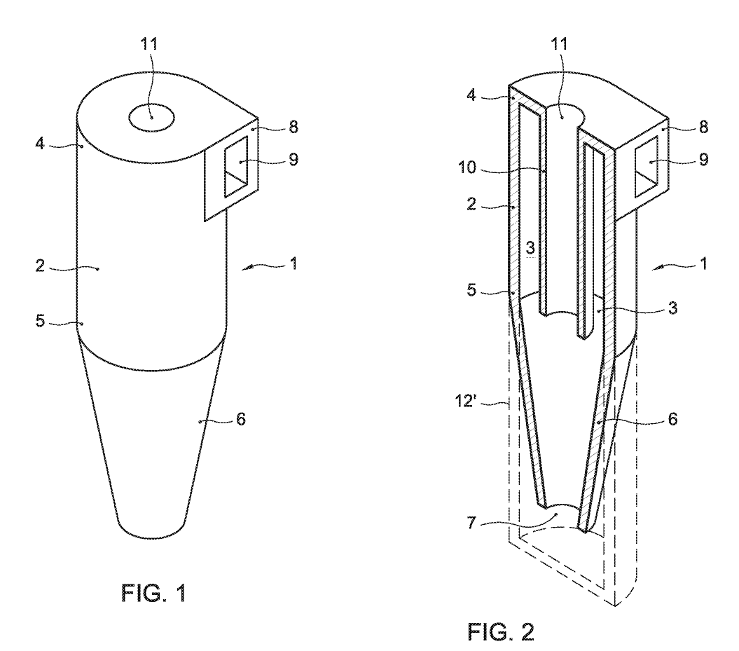

FIG. 1 shows a schematic view in perspective of a cyclone to be used in an embodiment of an apparatus according to the invention;

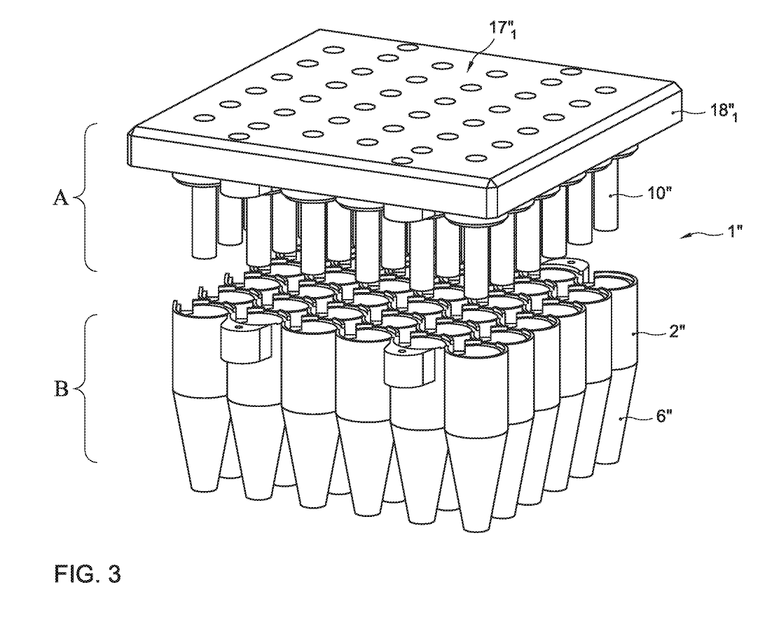

FIG. 2 shows a schematic view in perspective, partly broken away, of the cyclone of FIG. 1;

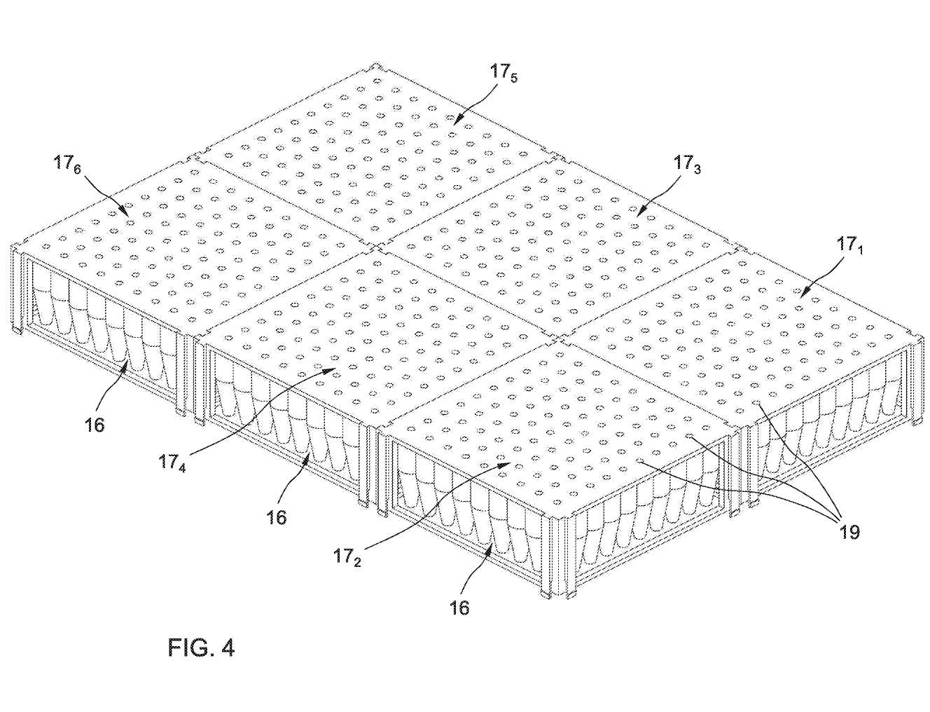

FIG. 3 shows a schematic view in perspective of a module of cyclones built up from two sub-units to be used in another embodiment of the invention;

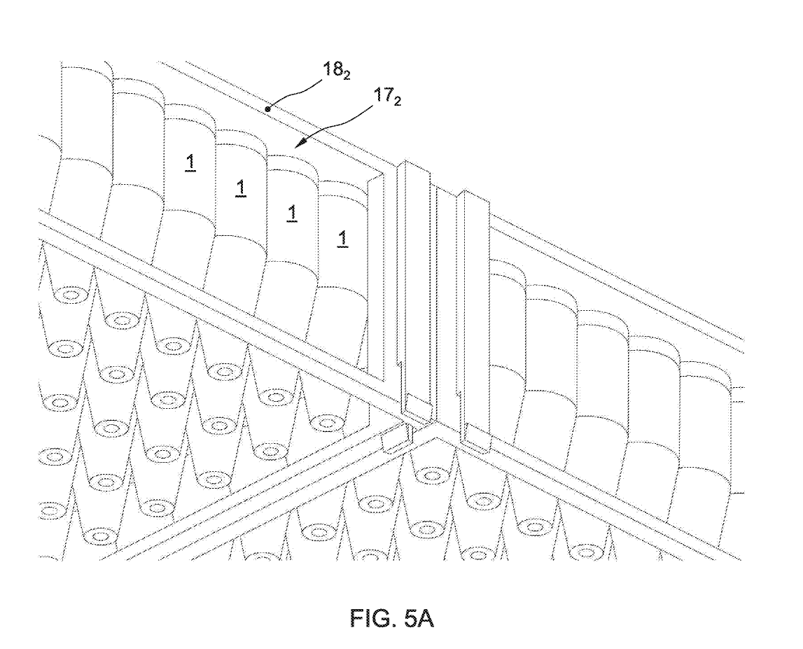

FIG. 4 shows a schematic view in perspective of six modules of cyclones coupled together, shown without a housing, to be used in a still further embodiment of the invention;

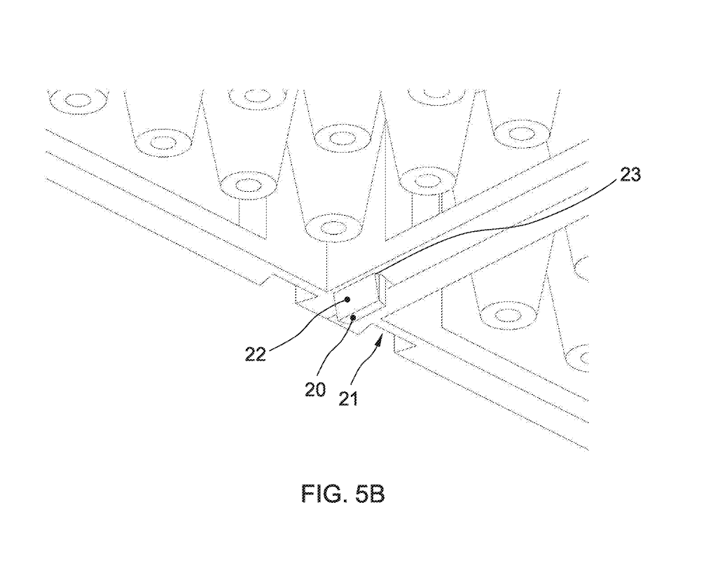

FIGS. 5A and 5B each show enlarged views from below of the embodiment shown in FIG. 4;

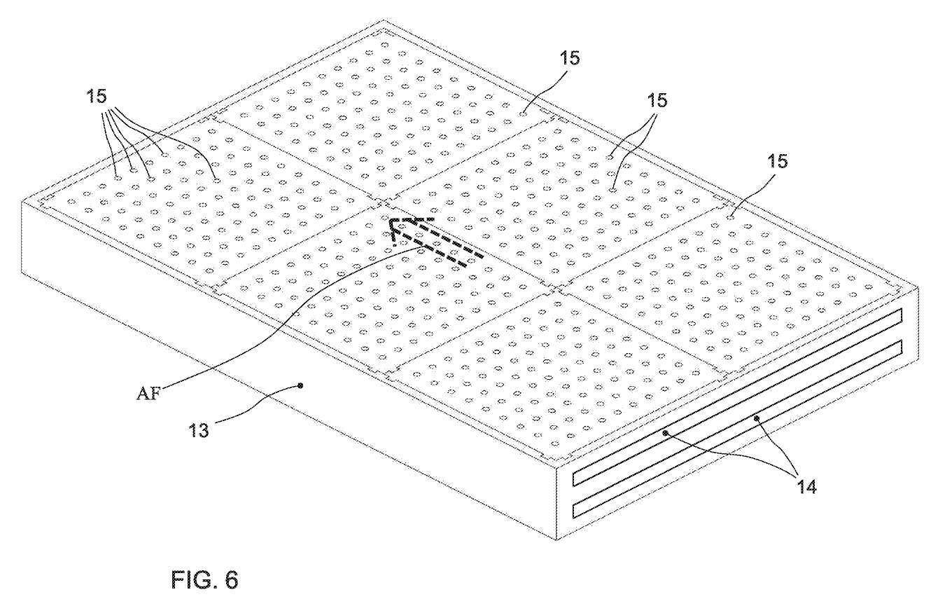

FIG. 6 shows a schematic view in perspective the embodiment of FIG. 4 with a housing, and

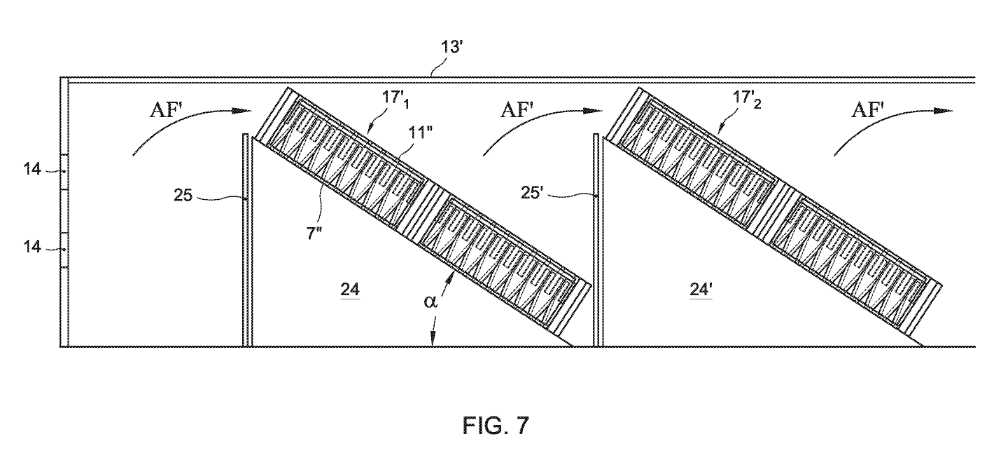

FIG. 7 shows a further embodiment of an apparatus according to the invention in which the modules are tilted.

The present invention relates to the use of cyclones for removing or separating dust from polluted air. The operation and construction of a cyclone is generally known and therefore will not be discussed in great detail. However, a short discussion will be given below regarding the relevant components of a multi-cyclone dust separating apparatus according to the invention with reference to FIGS. 1 and 2.

A cyclone 1 which can be used in an apparatus according to the invention comprises a cylindrical portion 2 defining an inside vortex space 3. The cylindrical portion 1 has a top end 4 and a lower end 5. A conical portion 6 is arranged contiguous to the lower end 5 and has a dust opening 7 at its bottom. The cyclone 1 further comprises an air inlet 8 arranged tangentially with regard to the cylindrical portion 2. The air inlet 8 opens into the inside vortex space 3 and has an effective air passage surface area 9. The cyclone 1 further comprises an air outlet tube 10 having an air outlet passage 11. The air outlet tube 10 is arranged at the top end 4 of the cylindrical portion 2 and extends over a length which is approximately equal to the length of the cylindrical portion 2. Between the outer surface of the air outlet tube 10 and the inner surface of the cylindrical portion 2 the inside vortex space 3 is formed.

During operation polluted air is pumped into the tangential inlet 8 of the cyclone 1 by means of e.g. a pump or a ventilator. The airflow with the air pollution is to circulate rapidly within the vortex space 3 so that solid dust particles are centrifuged from the air flow. Via the internal wall surfaces of the conical and cylindrical portion the dust particles leave the dust opening 7 at the bottom of the conical part 6. The air flow together with as yet non-separated particles leaves the cyclone 1 via the air outlet passage 11 at the top of the cylindrical portion 2.

In FIG. 2 an embodiment of a cyclone comprising an internal dust collector 12′ is indicated in broken lines. The internal dust collector 12′ is preferably removably connected in an air tight manner to the cyclone 1. Please note that with the expression internal is meant that the dust collector 12′ is part of or directly attached (preferably removable) to the cyclone. The invention will further be described using cyclones which do not comprise an internal dust collector, but wherein dust which is discharged via the dust opening 7 is collected by a separate external dust collector, as will be described below.

The multi-cyclone dust separating apparatus according to the invention further comprises a housing 13 (see FIG. 6) with an air inflow port 14, which can be formed from any number and shapes of inflow openings. An air outflow port 15 separate from the air inflow port 14 is present which is provided by all the air outflow passages of the individual cyclones 1. Between the air inflow port 14 and the air outflow port 15 an air flow channel 16 (FIG. 4) extends within the housing 13 in an air flow direction AF.

As shown in FIGS. 4 and 6 the modules of cyclones 17₁-17₆ are arranged in a matrix arrangement of 2 by 3 and are connected to each other in an airtight manner forming an assembled unit of modules. The modules are identical to each other and each module of cyclones 17₁-17₆ comprises a top module plate 18₂ (shown in FIG. 5A only for module 17₂ for convenience of drawing) to which a number of cyclones 1 is connected to. In the embodiments shown in FIGS. 4 to 6 the top module plate 18₂ of the cyclone module 17₂ is square having a plate area of 300×300 mm². Please note that in other embodiment the top module can be rectangular and can furthermore in other embodiments have different kinds of dimensions. The number of cyclones 1 in the shown embodiment is 81, but depending on the diameter of the cyclones in other embodiments any other amount of cyclones within said module having a square value between 25 and 1296 can be connected to the top module plate 18₂. In the shown embodiment six modules are releasably connected to each other in an air tight manner but in dependent of the capacity needed any other number of modules can be connected to each other to form an assembled unit of modules.

The top module plate 18₂ comprises through going air passages 19, each communicating with a respective air outlet tube of the respective cyclone 1 and together forming the air outflow opening 15.

The air passage surface area of the air inlets of all the cyclones belonging to each of the modules 17₁-17₆ is at least approximately identical.

As can be seen in FIGS. 4 to 6 the modules of cyclones can be releasably connected to one another by means of quick-coupling means 20, 21, 22, 23 so that no tools are necessary to connect or disconnect the modules to and from each other, respectively. Such a connection can also be used to connect the modules to the housing as is shown in FIG. 6. Such quick-coupling means are not described in detail here as they are well-known to persons skilled in the art. In addition the modules are connected in an air tight manner to each other and also such connections are readily available to a person skilled in the art.

In an alternative embodiment of a multi-cyclone dust separating apparatus as shown in FIG. 7 a first assembled unit of two modules of cyclones 17₁′ and a second assembled unit of two modules of cyclones 17₂′ are separated from each other and are mounted within the housing 13′ under a tilting angle α. As can be seen the tilting angle α is such that the dust openings 7″ of the cyclones of each module are directed towards the air inflow port 14. The assembled units are separated from each other and divider walls 25, 25′ define the air flow AF′.

In the embodiment shown in FIG. 7 the cyclones of the most upstream assembled unit of two modules 17′₁ have a larger air passage surface area of their air inlet then the air passage surface area of the air inlets of the cyclones of the adjacent downstream assembled unit of modules 17′₂. In the shown embodiment the larger air passage surface area is 3200 mm² (40 mm×80 mm), and the smaller air passage surface area has a value in a range between 2 mm² and 450 mm², in particular between 8 mm² and 32 mm². In this manner the apparatus can effectively separate dust having larger dimensions by the cyclones of the most upstream modules, while dust having the smallest dimensions is separated by the cyclones of the most downstream modules.

In this alternative embodiment of a multi-cyclone dust separating apparatus shown in FIG. 7 the apparatus comprises external dust collectors 24, 24′. Each external dust collector 24, 24′ is arranged such as to receive dust coming out of the dust openings 7″ of the cyclones of the respective assembled unit of modules and each dust collector is removably connected in an airtight manner to the respective assembled unit of modules.

In FIG. 3 an embodiment of a module 17₁″ is shown in which the air outlet tubes 10″ of the cyclones 1″ of the module are integrally connected to the top module plate 18₁″ to form a first sub-unit A. The cylindrical portion 2″ and the conical portion 6″ of a cyclone 1″ of the module are integrally connected to cylindrical portions 2″ and conical portions 6″ of adjacent cyclones of the module to form a second sub-unit B. The sub-units A and B are releasably connectable in an airtight manner to one another to form the module. In this manner maintenance and cleaning of the cyclones within the module 17₁″ can be performed in an easy manner. The sub-units A and B are each formed of a plastic and are made by injection moulding.

1. A multi-cyclone dust separating apparatus comprising:
a housing with an air inflow port, an air outflow port separate from the air inflow port and an air flow channel extending in an air flow direction from the air inflow port to the air outflow port;
a plurality of cyclones mounted inside the housing and arranged in the air flow channel, said plurality of cyclones being arranged in a matrix arrangement, each cyclone comprising:
a cylindrical portion defining an inside vortex space, said cylindrical portion having a top end and a lower end;
a conical portion contiguous to the lower end and having a dust opening at its bottom;
an air inlet arranged tangentially with regard to the cylindrical portion and opening in the inside vortex space, said air inlet having an effective air passage surface area; and
an air outlet tube having an air outlet passage, said air outlet tube being arranged at the top end of the cylindrical portion and extending into the inside vortex space,
said plurality of cyclones comprising at least one module of cyclones, said at least one module of cyclones comprising a top module plate to which a number of cyclones is connected to, said top module plate comprising through going air passages, each communicating with a respective air outlet tube, the air passage surface area of the air inlet of all the cyclones of the number of cyclones of said at least one module being at least approximately identical.

2. A multi-cyclone dust separating apparatus according to claim 1, wherein said apparatus comprises at least a first module of cyclones and at least one further module of cyclones, the first module of cyclones being releasably connected in an airtight manner to the at least one further module of cyclones forming an assembled unit of modules, said first module of cyclones being arranged in the housing upstream of the at least one further module of cyclones or said at least one further module of cyclones being arranged transversely adjacent the first module of cyclones, seen in a direction transverse to the air flow direction, the air passage surface area of the air inlet of the cyclones of said at least one further module and being equal to the air passage surface area of the air inlet of the cyclones of the first.

3. A multi-cyclone dust separating apparatus according to claim 2, wherein each module of cyclones comprises connection means arranged for providing a releasable connection to another module of cyclones.

4. A multi-cyclone dust separating apparatus according to claim 3, wherein the connection means are quick-coupling means.

5. A multi-cyclone dust separating apparatus according to claim 1, wherein the multi-cyclone dust separating apparatus comprises a first module of cyclones and a second module of cyclones separated from the first module of cyclones, said first module of cyclones being arranged in the housing upstream of the second module of cyclones, the air passage surface area of the air inlet of the cyclones of said first module being larger than the air passage surface area of the air inlet of the cyclones of said second module.

6. A multi-cyclone dust separating apparatus according to claim 5, wherein the top module plate of each module of cyclones is mounted in the housing under a tilting angle, the tilting angle being such that the dust openings of the cyclones of each module are directed to the air inflow port.

7. A multi-cyclone dust separating apparatus according to claim 2, wherein the multi-cyclone dust separating apparatus comprises a first assembled unit of modules and a second assembled unit of modules separated from the first assembled unit of modules, said first assembled unit of modules being arranged in the housing upstream of the second assembled unit of modules, the air passage surface area of the air inlet of the cyclones of said first assembled unit of modules being larger than the air passage surface area of the air inlet of the cyclones of said second assembled unit of modules.

8. A multi-cyclone dust separating apparatus according to claim 7, wherein the top module plate of each module of each assembled unit of modules cyclones is mounted in the housing under a tilting angle, the tilting angle being such that the dust openings of the cyclones of each module of each assembled unit of modules are directed to the air inflow port.

9. A multi-cyclone dust separating apparatus according to claim 2, wherein the modules of cyclones are identical to each other.

10. A multi-cyclone dust separating apparatus according to any one of the preceding claims, wherein each of the cyclones further comprises an internal dust collector.

11. A multi-cyclone dust separating apparatus according to claim 1, wherein the apparatus comprises an external dust collector releasably connected in an airtight manner to a module of cyclones.

12. A multi-cyclone dust separating apparatus according to claim 2, wherein the apparatus comprises an external dust collector releasably connected in an airtight manner to an assembled unit of modules.

13. A multi-cyclone dust separating apparatus according to claim 1, wherein the effective air passage surface area of the cyclones of said at least one module of cyclones has a value in a range between 4 mm² and 250 mm².

14. A multi-cyclone dust separating apparatus according to claim 1, wherein the air outlet tubes of the cyclones of said at least one module of cyclones are integrally connected to the top module plate to form a first sub-unit and the cylindrical portion and conical portion of the cyclones of said at least one module are integrally connected to the cylindrical portions and conical portions of adjacent cyclones to form a second sub-unit and the first and second sub-units are releasably connected to each other in an airtight manner to form the at least one module.
